(19) United States
(12) Patent Application Publication
(10) Pub. No.: US 2025/0298659 A1
(43) Pub. Date: Sep. 25, 2025

(54) SYSTEMS FOR EXECUTING ARTIFICIAL INTELLIGENCE/MACHINE LEARNING MODELS ON HETEROGENOUS COMPUTING DEVICES

(71) Applicant: NXP USA, Inc., Austin, TX (US)

(72) Inventors: Dong Zheng, Ottawa (CA); Daniel Claude Laroche, Kemptville (CA); Xiaoyin Xu, Ottawa (CA); Alexandru Iulian Taran, Sadova (RO); Jonathan Scott Hills, Nepean (CA); Brady Nicholas Laska, Arnprior (CA)

(21) Appl. No.: 19/063,716

(22) Filed: Feb. 26, 2025

(30) Foreign Application Priority Data
Mar. 20, 2024 (RO) A202400118

(51) Int. Cl. G06F 9/48; G06F 9/448

(52) U.S. Cl. CPC G06F 9/4881; G06F 9/448

(57) ABSTRACT

A hardware- and software-aware metagraph is deployed in conjunction with a corresponding artificial intelligence/machine learning (AIML) model onto heterogeneous and mixed-precision devices to enable flexible generic runtime with minimum control overhead for synchronization, automatic insertion of data transfers and conversions, reuse of graphs from application to application for different hardware and software configurations, and enablement of single, batch, and pipeline execution. The metagraph is independent of the existing AIML training/inference frameworks and can extend to broader scope of general heterogenous computation, also can be used by offline/runtime to enable solutions from heterogenous deployment to optimal execution scheduling and network structure fine tuning.

### TECHNICAL FIELD

Embodiments of the present disclosure relate to operations of machine learning and other artificial intelligence models on heterogenous computing devices and, more specifically, to systems and methods for enabling multi-level parallel execution scheduling of modeling tasks based on the capabilities of the device's available computing hardware.

### BACKGROUND

In a digital computer system, “heterogenous computing” refers to the use of a plurality of processors of different types to perform different tasks; advantageously, the tasks can be performed, sometimes in parallel, by specialized processors that optimize the performance and thus increase efficiency of the computation executions. For example, a heterogenous computing device may include multiple central processing unit (CPU) cores, graphics processing unit(s) (GPUs), digital signal processor(s) (DSPs), and other types of processors, various types of onboard memory, and one or more communication busses, as well as hardware and software to handle task scheduling, data synchronization, load balancing, memory management, and other co-processing management tasks.

Due to the diversified capabilities of its computing environment, a heterogenous computing device may serve as a useful platform on which to execute machine learning functions. For example, machine learning models are often represented as computational graphs that represent the flow of data through different layers of the model; many operations in these models, such as matrix multiplications, convolutions, and activation functions, can be performed independently on different parts of the input data, allowing for parallelization at the node level. On a heterogenous computing device, the node-level tasks can be distributed to corresponding processors that are optimally effective at executing them.

Generally, the software framework that is used to build a machine learning model is the element of the computing system that handles parallelization tasks such as data transfer and device synchronization. The most widely-used software frameworks for creating machine learning models are open-source training frameworks such as TENSORFLOW and PYTORCH. While these frameworks are easily accessible and well understood, they are also hardware agnostic. In the context of heterogenous computing devices, this becomes a drawback because the deployed machine learning models have not been trained to optimize execution within a particular heterogenous (i.e., diversified hardware) environment. It would be advantageous to provide systems and methods of generating machine learning models that are aware of the hardware configurations on which they are executed, in order to optimize such execution.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram depicting functional components and an execution environment for a metagraph-enabled artificial intelligence/machine learning (AIML) model executing on a computing device, in accordance with this disclosure.

FIG. 2 is a block diagram depicting an example execution flow of meta-enabled subgraphs in accordance with this disclosure.

FIG. 3 is a block diagram depicting another example execution flow of meta-enabled subgraphs in accordance with this disclosure.

FIG. 4 is a block diagram depicting an example execution flow of subgraphs in a frame pipeline in accordance with this disclosure.

FIG. 5 is a block diagram depicting an example batch processing execution flow of subgraph frames in accordance with this disclosure.

FIGS. 6A and 6B are block diagrams depicting an example system for creating and deploying a metagraph-enabled AIML model to a computing device in accordance with this disclosure.

### DETAILED DESCRIPTION

It will be readily understood that the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

Embodiments of this disclosure may present in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

For simplicity, the described features, advantages, and characteristics of the invention are described throughout this specification may be described as being implemented within an embedded device, a SoC, or an assembly of SoCs interconnected by a communication bus such as PCIe, CAN, or Ethernet (i.e., in a distributed computing environment), each including one or more microprocessors, other processing units such as discrete hardware accelerators, programmable or non-programmable memory, and other integrated circuits as well as individual circuit components and other pieces of electronic equipment. In particular, this disclosure refers extensively, and pertains, to implementations within a heterogenous computing environment. In general, the term “heterogeneous computing” or “hybrid computing” may particularly denote any strategy of deploying multiple types of processing elements within a single workflow, and allowing each processing element to perform tasks (for instance software tasks, hardware tasks, or hybrid tasks) to which it is best suited. However, the present devices and methods may be implemented in other digital computing systems and devices for which machine learning models directed by a hardware- and software-aware metagraph as described would be useful.

This disclosure provides systems and methods for creation, deployment, and runtime execution of artificial intelligence/machine learning (“AIML”) models in heterogenous computing environments, wherein the AIML models include one or more hardware- and software-aware meta graphs including information that optimizes the execution of model-associated tasks for a heterogenous computing device, such as a system-on-chip (SoC), with a given hardware composition and layout. A meta graph in accordance with this disclosure may define: hardware-specific meta information mapping the AIML model to a specific device configuration, enabling heterogenous execution with associated performance and memory cost; corresponding meta information to signal subgraph parallel execution and synchronization, to improve inference performance; meta information for format conversions (e.g., to indicate mixed data types, mixed precision, add data precision, etc.) between different graphs and subgraphs; and, a graph-level scheduling profile to minimize overhead of runtime decisions such as graph execution order and target assignment.

Systems are provided to support the present meta graph implementations both as part of an AIML toolkit and for deployment in embedded device systems. The supporting systems may include both offline tools (run on cloud or desktop) and runtime software (on embedded platform). The offline tools can be used to create the present meta graphs based on particular AIML models, device computing and backend capabilities, device performance, memory, layout, usage information, and the like; the offline tools can further generate execution scheduling profiles, add data transfer/conversion handling if needed, and define parallel execution regions through meta primitives (e.g., to allow frame pipeline or batch parallel processing, to improve performance/throughput, to perform hardware target-based profiling, and otherwise to accurately update device backend information). Runtime software will map a generated meta graph to a given hardware (e.g., a SoC, a plurality of interconnected SoCs, or other heterogenous combinations of discrete hardware components) and backend for execution, select execution scheduling based on cost information defined in the meta graph together with hardware and software resource constraints and capabilities in the system, and perform frame/batch parallel execution.

In general, the embodiments described herein provide for improved flexibility and optimized execution of artificial intelligence/machine learning (AIML) models in heterogenous computing environments using a directed metagraph to select, schedule, and batch-execute AIML graphs and algorithms on an embedded device according to the available hardware and software resources of the device. The systems and methods disclosed herein resolve drawbacks in existing machine learning models, such as those from open-source training frameworks, that are hardware-agnostic and thus are difficult to optimize for execution in heterogenous computing environments. In particular, the present systems decompose the AIML graph calculation at the system level and use meta graphs to optimize for the fact that different hardware cores may be running different software frameworks with associated capabilities and limitations. This allows for accuracy in a higher level of scheduling and load balancing that may include multiple frames of data, multiple networks, or multiple applications running simultaneously. The metagraph defines scheduling profiles for runtime software to construct a parallel execution pipeline according to system computation capabilities and available resources; the metagraph also supports mixed precision graph execution by defining data transfer and precision/layout conversion handling subgraphs. The metagraphs can also support multiple applications with minimized storage requirement for common subgraphs presented in different execution branches.

Embodiments of the present systems and methods can be implemented within any presently known or subsequently developed embedded device, accounting for any hardware backend and other architecture and for various software frameworks that can operate on a given hardware configuration. To simplify the explanations within this specification for clarity, the Figures depict, and the present description uses, a small example set of directed graphs and subgraphs that are representative of a typically large and complex deep neural network (DNN) or other graph-based AIML model featuring graph nodes that include computation bodies, such as Open Neural Network Exchange (ONNX) or TENSORFLOW containers, compiled binary “blobs,” or other customized processing functions. It will be understood that in practice an AIML model can include thousands of subgraphs, and other model components, that can be configured so that the present implementations of hardware- and software-aware metagraphs support them; the principles described in this document will apply to any such AIML model, with respect to both the graph-building aspects and the runtime aspects of the metagraphs as described herein. Additionally, references to particular AIML model types (e.g., “deep convolutional neural network”), formats (e.g., PYTORCH, GLOW, ONNX, TENSORFLOW container format), and components (e.g., VELA compiler, TENSORFLOW LITE (“TFLite”) inference engine), and to particular hardware components (e.g., CORTEX-M7 and other ARM processors, DSPs, NXP NEUTRON neural processing unit (NPU)), are non-limiting examples of those that are compatible with the metagraphs, metagraph builder, and metagraph runtime execution described herein.

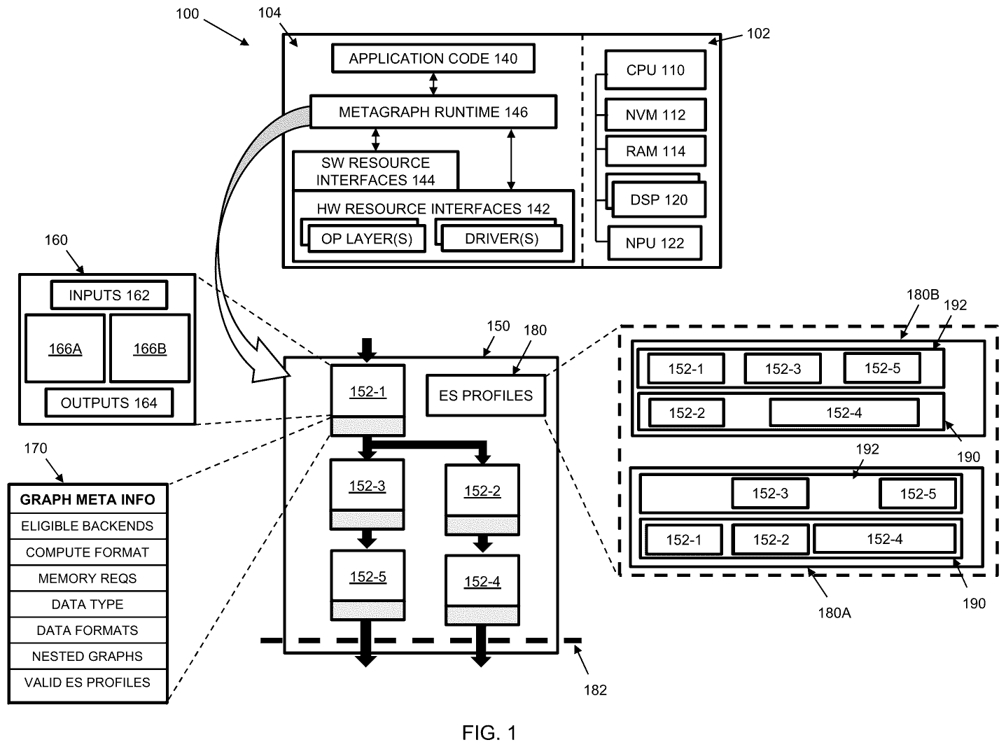

FIG. 1 illustrates an example computing device 100, such as a system-on-chip (SoC) or an embedded computing device or distributed computing system including one or more communicatively connected (e.g., by an interconnection framework such as a communication bus or wired or wireless network) SoCs, that includes a heterogenous plurality of processing elements within its hardware arrangement 102, as well as a software execution environment 104 implemented by cooperating processors and memory of the hardware arrangement 102. The device 100 is intended as a generic representation of the heterogenous embedded devices that can be characterized by the metagraphs described herein, and that can execute a metagraph-equipped AIML model as described herein. It will be understood that the device 100 is in some respects an abstraction, and that the actual organization of the components of the device 100 may be more complex than illustrated. For example, the device 100 may include a plurality of SoCs, such as a first SoC that performs primary scheduling and processing tasks, and a second SoC that performs hardware or graphic acceleration; the device 100 may further include co-processors, memory devices, etc., that are internal or external to a SoC or that may have limited accessibility to other components of the device 100. These variations in composition and structure are contemplated in the present disclosure.

The device 100 can include a central processing unit (CPU) 110, various memory such as non-volatile memory (NVM) 112 and random-access memory (RAM) 114, and various co-processors or special-purpose processors such as one or more digital signal processors (DSPs) 120 and a neural processing unit (NPU) 122. Any of the processors may be any hardware device capable of executing instructions stored in memory (e.g., NVM 112) or storage or otherwise processing data. As such, the processor may be or include a microprocessor, microcontroller, graphics processing unit (GPU), neural network processor, field programmable gate array (FPGA), application-specific integrated circuit (ASIC), or other similar devices. The processor may have a single core or multiple cores and may be capable of multithreaded processing. An example CPU 110 in this context may be the ARM CORTEX-M7; an example DSP 120 may be the CADENCE TENSILICA HIFI 4 or FUSION F1, and an example NPU 122 may be the NXP NEUTRON NPU. While the device 100 is shown as including one (or two) of each described component, the various components may be duplicated in various embodiments. For example, the CPU 110 may include multiple microprocessors that are configured to independently execute the methods described herein or are configured to perform steps or subroutines of the methods described herein such that the multiple processors cooperate to achieve the functionality described herein.

The memory may include, in addition to or instead of NVM 112 and RAM 114, various memories such as, for example L1, L2, or L3 cache or system memory; the memory may include static random-access memory (SRAM), dynamic RAM (DRAM), flash memory, read only memory (ROM), or other similar memory devices. Some types of memory may be on-chip or internal to a processor, while others may be standalone memory devices accessible by one or more of the processors. The memory may be considered to be a “storage device,” and may further include other machine-readable storage media such as magnetic disk storage media, optical storage media, flash-memory devices, or similar storage media. One or more interconnection frameworks, such as a system bus, allows communication between the processors and memory of the hardware arrangement 102 to implement the software execution environment 104.

The memory of the device 100 may store instructions for execution by the processors or data upon which the processors may operate. In particular, the memory may store instructions for execution by the processor(s) to carry out the functions of metagraph-enabled AIML models, including metagraph runtime execution determinations, graph and related process scheduling, and other execution of the AIML model. FIG. 1 provides an example metagraph 150 representing an AIML model as a directed graph. The AIML model represented may be any model type that can be suitably implemented as a directed or semantic graph, such as a deep neural network (DNN), Bayesian network, graph convolutional network, and the like. As described further below, the AIML model may be built using any presently available or later developed machine learning development tools and frameworks, including open-source training frameworks such as ONNX and TENSORFLOW, as well as proprietary frameworks that include custom graphs and processing functions. The metagraph 150 is, effectively, an optimized graph-based partitioning of the AIML model, which is then annotated to account for the hardware arrangement 102 and software execution environment 104 of the device 100 during distribution of execution tasks in order to efficiently execute the AIML model.

That is, in accordance with this disclosure, the metagraph 150 is constructed based on a determination that the device 100 may have available multiple paths of supportive infrastructure, referred to herein as “backends,” on which various portions of the AIML model may be most efficiently executed. A backend may include or be composed of or defined by one or more hardware computing resources that can be allocated for execution of the model, including some or all of the resources of any of the components of the hardware arrangement 102. Some such components are well suited for executing certain tasks, and poorly suited for executing others. For example, an AIML model for object detection applications may partition tasks into stages, and the tasks in each stage have characteristics that make either a CPU 110 or a DSP 120 the optimal hardware for executing the tasks. A first stage may include a series of “network backbone” data collection and pre-processing tasks, such as reading input data including images and sensor inputs, resizing and normalizing images, and the like. These tasks may be best handled by the CPU 110 due to its processing and memory management versatility. A second stage may include analyzing the preprocessed data from the first stage to identify features in the data to be extracted for object detection; these tasks may require very fast but computationally intensive processing, and may best be executed on a DSP 120. A third stage of object detection, or “inference,” tasks includes executing the object detection model to identify objects in the extracted feature set; either the CPU 110 or the DSP 120 may be capable of performing these tasks, with a selection of the optimal hardware being dependent on the complexity of the model, the availability of hardware computing resources, or both, as well as whether or not real-time detection is needed given the application. Finally, a series of postprocessing tasks such as filtering, sorting, and managing results of the executed model may be executed on the CPU 110.

It will also be understood that, in various embodiments, the different processors of the hardware arrangement 102 may have different instruction sets, architectures, pipelines, data precisions, etc., that affect which of two available processors would be the better choice to execute a given portion of the AIML model. Similarly, different types of memory present different benefits and detriments. The set of available backends represents the various options for hardware execution on the device 100.

Additionally, a backend may include or be composed of or defined by one or more software resources, one or more software-related constraints, or a combination thereof. The metagraph 150 may take software-specific features along with the hardware features and represent their different combinations as possible execution backends. In one example, memory usage requirements for computation/execution of a given subgraph within the metagraph 150 may itself be one of the software-related constraints affecting configuration of the backend(s); that is, subgraph execution may be associated with the performance of available hardware configurations based on required vs. available computing resources. The hardware arrangement 102 implements the software execution environment 104, enabling execution of software such as application code 140 of programs stored on the device. In various embodiments, the application code 140 may be code for custom programs created to be run on the device 100 by an owner or developer. The application code 140 may include applications (i.e., programs) that use the AIML model, and thus cause the metagraph runtime 146 to execute-such applications are referred to herein as “AIML applications.” The application code 140 can also include custom programs that are not AIML applications; nevertheless, because they are executing in the software execution environment 104, these programs consume hardware computing resources that could otherwise be allocated to execution of the AIML model.

The hardware computing resources are also managed, and thus directly affected, by hardware resource interfaces 142 that execute at least partially in the software execution environment 104 to provide hardware abstraction, enabling software to use the processors and memory. Non-limiting example hardware resource interfaces 142 may include one or more operations, or “op” layers that each provide abstraction of an instruction set used by one or more of the processors, and one or more device drivers that enable a particular operating system or other piece of software to operate or control a particular component in the hardware arrangement 102. Additionally, various software resource interfaces 144 may be executing to provide runtime interpretation, library and other function calls, and the like. For example, the device 100 may be executing an inference engine, such as GLOW, or another AIML processing backend, in connection with the metagraph runtime execution 146. In some embodiments, the software resource interfaces 144 may include interfaces to an operating system of the device 100, or may include the operating system itself. Software constraints included in the set of backends may include software formats. For example, portions of the AIML model may be stored in the metagraph 150 in various container formats or as precompiled binary executables. Additionally, some types of AIML model structures have multiple internal formats. For example, in a TENSORFLOW model, data is structured into n-dimensional arrays known as “tensors,” which can be organized according to one of several memory formats pertaining to the order in which the values representing a multidimensional tensor are stored in memory.

The metagraph 150 may further account for embodiments of the device 100 in which a given hardware component, such as a hardware accelerator, may be compatible with several compilers (e.g., APACHE TVM, NVCC, GLOW) that translate high-level code into hardware-specific instructions; each compiler, in turn, may be compatible with multiple high-level programming languages or frameworks (e.g., CUDA, OPENCL, PYTORCH). Moreover, any of the accelerators in a multi-accelerator computing device may be tightly coupled to a software or hardware execution framework provided by the accelerator manufacturer (or another third party); such frameworks may have dedicated extensions to leverage certain architectural aspects of the associated accelerator. At the time the metagraph 150 is built (as described below), the specific hardware accelerator and its characteristics may be known, but the specific complier used by the hardware accelerator, with respect to the device 100, may be unknown. The metagraph 150 may include different backends configured to account for the different compilers potentially used onboard the device 100. For example, a given subgraph may, as described below, include meta info, one or more computation bodies, or both, for each of a plurality of compilers, with scheduling information enabling selection of the appropriate computation body for execution at runtime. The different computation bodies may receive input and produce output in different data types or formats, thus creating additional software constraints that are accounted for in determining the available backends. Thus, it will be understood that, in some embodiments, the “software awareness” of the metagraph 150 may be embodied in the respective one or more computation bodies of each of the subgraphs, with each computation body representing the best optimization, or one of several possible optimizations, of runtime execution of the subgraph given the available computing resources of the hardware arrangement 102 of the computing device 100.

The metagraph 150 may use the backends to efficiently map execution of the AIML model to the computing device 100. In some embodiments, such mapping may include associating graph portions of the AIML model with compatible hardware computing resources, based on limitations imposed by software (e.g., compatible instruction sets) and resource availability. Additionally or alternatively, such mapping may include organizing, based on their connections, graph portions into a frame pipeline for parallel execution, optimizing throughput. It will be understood that the depicted metagraph 150 is simplified for purposes of description and, in practice, may be many times larger (i.e., may include or be composed of tens or hundreds of subgraphs) and more convoluted, depending on the size and design of the AIML model the metagraph represents; nevertheless, compared to existing solutions, an implementation of the present metagraph 150 serves to reduce complexity at runtime while maintaining flexibility, by minimizing the number of subgraphs and reusing them where appropriate. The depicted metagraph 150 can be considered a “snippet” of a metagraph for a complete AIML model, or a reduced representation of the complete metagraph, but in any case is sufficiently demonstrative for a complete disclosure of the present systems and methods. The metagraph 150 includes a plurality of subgraphs 152-1 . . . 5 including portions of the AIML model. Each subgraph 152-1-5 includes its own graph entity 160 and its own meta information 170 corresponding to the subgraph 152-1-5. The graph entity 160 is a container or other data structure storing information and data that corresponds to the portion of the AIML model that the corresponding subgraph represents. Such data may describe the expected input(s) 162 to the subgraph, the output(s) 164 of the subgraph, and identifiers of the down-graph subgraphs that should receive the outputs. In this way, the graph entity 160 describes the up-graph and down-graph edges that connect to the subgraph 152-1 within the directed (or semantic) graph of the corresponding AIML model.

Additionally, the graph entity 160 may store or reference one or more pieces of executable code, or “computation bodies,” that may be executed to perform the functions of the portion of the AIML model represented by the subgraph. A computation body 166A may include elements of the model structure, including graph nodes and edges, model weights and biases, selected and supported operations, and the like. A computation body 166A may in some embodiments be unchanged by the creation of the metagraph 150, and so may be stored in a format native to the AIML model, such as an ONNX or TENSORFLOW container; or, the computation body 166A may be an ahead-of-time (AOT) compiled object binary executable. In some embodiments, the metagraph 150 can conserve memory usage by storing a single copy of the computation body 166A, even though a plurality of branches (i.e. directed paths through the arrangement of subgraphs 152-1 . . . 5) run from (or through) the corresponding subgraph 152-1. In some embodiments, to support multiple backends, the graph entity 160 may store multiple computation bodies 166A, 166B representing the same portion of the AIML model but in different formats. For example, a first computation body 166A may be stored as an AOT compiled binary executable, and a second computation body 166B may be stored as an ONNX container that will be interpreted at runtime. As explained further below, the corresponding subgraph 152-1 may be assigned at runtime to a particular backend for execution, and the appropriate stored computation body 166A, 166B may be selected based on the assigned backend. Additionally or alternatively, the appropriate computation body 166A,B may be selected based on the format required by a user-provided program executing (i.e., in application code 140) on the device 100.

The meta information 170 may be a container or other data structure storing information describing the subgraph 152-1 itself, including the graph entity 160 and its contents. At execution, the metagraph runtime process 146 uses the meta information 170 along with information describing the available computing resources of the device 100 to assign the execution of the subgraph 152-1 to one of the backends. Thus, the meta information 170 may include identifiers of which of the available backends may be optimally, or compatibly, configured to execute the subgraph 152-1. By identifying compatible backends, the meta information 170 specifies corresponding hardware target(s) from among the hardware computing resources of the hardware arrangement 102. The meta information 170 may further identify the subgraph's 152-1 compatible format(s), such as those of the stored computation body/ies 166A,B, data types, data precision, memory formats (e.g., for stored tensors), and the like. The meta information may further include benchmarked and otherwise measured values for expected computation cost associated with executing the subgraph 152-1, such as memory size, type, and location, and other memory requirements, memory access cost, hardware (i.e., processing resource) cost, execution duration, and the like. Additionally, the meta information 170 may indicate whether the subgraph 152-1 includes nested graphs (i.e., multiple further-divided subgraphs within the subgraph) or nested data dependencies (e.g., a mapping of the computing body to multiple hardware accelerators, which behaves like a single accelerator mapping from the perspective of the metagraph 150). The meta information 170 may also indicate which of the execution scheduling (ES) profiles 180 are valid for the subgraph 152-1, For example, the subgraph 152-1 may indicate that it is not eligible for parallel processing (e.g., within a frame pipeline as described below).

The metagraph 150 may further include a plurality of execution scheduling (ES) profiles 180 to define execution workflows of the subgraphs 152-1-5 and capability/cost associated with each workflow. Generally, each of the profiles 180 assigns the plurality of subgraphs 152-1-5 across the available backends for sequential or parallel execution or both sequential and parallel execution; such assignment determinations may be based on information about graph execution order, derived from the metagraph 150 layout (i.e., edges, edge direction, and data dependencies), and on the computation cost and associated memory requirement for executing a subgraph 152-1-5, which may be obtained or derived from the meta information 170 of each of the subgraphs 152-1-5. Additionally, the scheduling (i.e., assignments to the backends) may be determined based on the ability to execute various of the subgraphs 152-1-5 in parallel across multiple backends, which may also be derived from the meta information 170 of each subgraph 152-1-5 (e.g., the corresponding compatible backends, or an indicator whether the subgraph 152-1-5 can be parallelized, or both). In some embodiments, the metagraph 150 may include one or more synchronization (“sync”) barriers 182 between subgraphs or across branches of the metagraph 150. A sync barrier 182 is a data element or program function that causes one or more of a set of parallel-executing threads to synchronize execution at a certain point and wait until all threads reach the sync barrier 182 before continuing to perform tasks. The illustrated example metagraph 150 includes a sync barrier 182 across the two illustrated branches, indicating that for the fourth subgraph 152-4 and fifth subgraph 152-5, once one is done executing, its subsequent subgraph should not be executed until the other is done executing; then, both branches can proceed simultaneously. The scheduling of the ES profiles 180 account for all sync barriers 182 as well.

FIG. 1 illustrates two example ES profiles 180A, 180B that schedule the plurality of subgraphs 152-1-5 differently across two available backends 190, 192. In the example, the first subgraph 152-1 is capable of being executed on both the first backend 190 and the second backend 192; the second subgraph 152-2 and fourth subgraph 152-4 can only execute on the first backend 190 and the third subgraph 152-3 and fifth subgraph 152-5 can only execute on the second backend 192. Additionally, the third subgraph 152-3 has a data dependency from, and cannot be executed in parallel with, the first subgraph 152-1. These limitations produce two ES profiles: in a first ES profile 180A, the first subgraph 152-1 is executed on the first backend 190, and consequently the second subgraph 152-2 and third subgraph 152-3 are held until the first subgraph 152-1 is finished executing, then they are executed in parallel; in a second ES profile 180B, the first subgraph 152-1 is executed on the second backend 192, so the second subgraph 152-2 can be executed in parallel on the first backend 190, and this parallelization allows the set of subgraphs 152-1-5 to be executed more quickly than in the first ES profile 180A.

In some embodiments, the scheduling may be further guided by user preference information describing an execution goal to be achieved. For example, a user may specify (e.g., select from a finite list) one that maximizes throughput of subgraph execution, or that most efficiently uses hardware computing resources, or that causes the fewest memory accesses, etc. In some embodiments, a set of selectable execution goals may be included in the ES profiles 180 and means (e.g., an application programming interface) for selecting the execution goal may be used by the AIML application(s) executing in the software execution environment 104.

The various ways that the subgraphs 152-1-5 can be scheduled for execution may be analyzed (in advance, as described below) to produce the plurality of ES profiles 180 and store them on the device 100 in association with the metagraph 150. The set of ES profiles 180 can be pulled or otherwise accessed at runtime to analyze, based on hardware capability and real-time availability and software compatibility, which of the ES profiles 180 best satisfies the execution goals (default or user-defined) considering the availability of the subgraphs' corresponding hardware targets (i.e., the hardware computing resources on which the subgraph would optimally be executed), and then schedule execution of the subgraphs 152-1-5 on the corresponding backends according to the scheduling specified in the optimal ES profile 180.

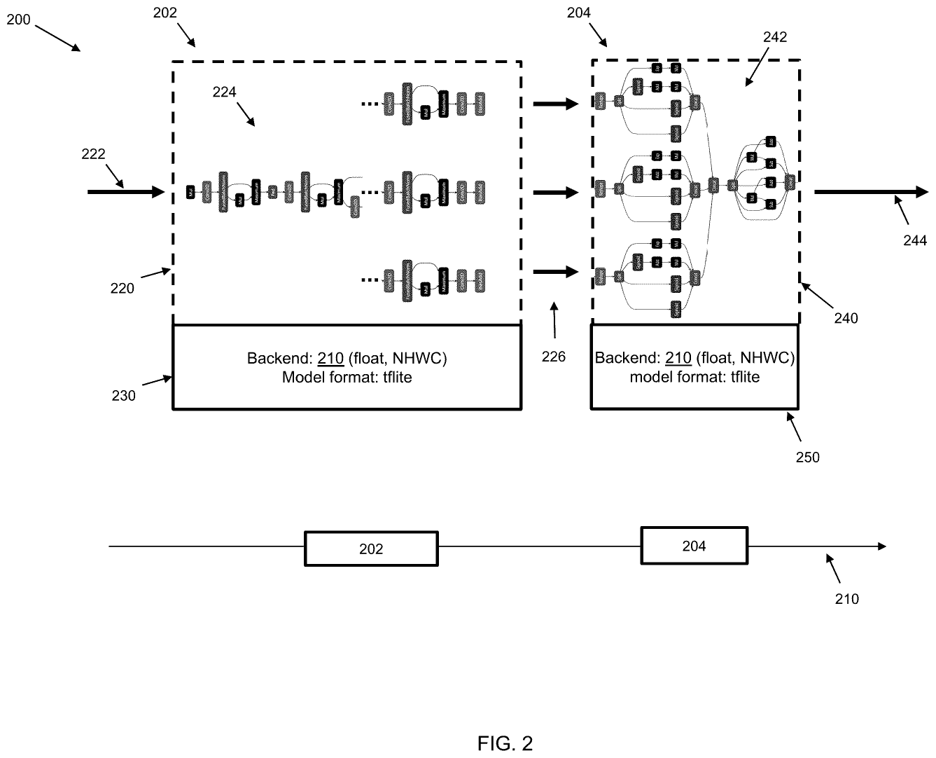

FIG. 2 illustrates an example portion of a metagraph 200 as described above. The example depicts a simple sequential execution of a first subgraph 202 and then a second subgraph 204 on the same backend 210. A container 220 of the first subgraph 202 may include data structures, executable code, or other information for receiving input 222 from a previous subgraph (not shown), or a combination thereof. Based on the input 222, the computing body 224 (here, a tensor including a portion of a branching directed graph) of the first subgraph 202 is executed, producing a plurality of outputs 226. These outputs 226 then become the inputs of the second subgraph 204 and are used to execute the computing body 242 (here, a tensor including a portion of a branch-resolving directed graph) stored in or referenced by the container 240 of the second subgraph 204, producing an output 244 that is provided to a subsequent subgraph (not shown) as defined by the container 240.

The subgraphs 202, 204 each include corresponding meta information 230, 250 that is used to create the ES profiles of the metagraph 200 and, ultimately, to schedule execution of the subgraphs 202, 204. In this case, each meta information 230, 250 identifies, for each subgraph 202, 204: the compatible backend (i.e., a first backend 210); the data precision of the input and output (float [ing point]); the memory format of the data used in each compute body 224, 242 (NHWC); and, the format of the original AIML model from which the graph portions are derived (TFLite). The corresponding meta information 230, 250 indicates that all of the graph parameters between the subgraphs 202, 204 match; no data transfer or format conversion is needed. The corresponding subgraph 202, 204 executions cannot be parallelized because the subgraphs 202, 204 must be run on the same backend 210.

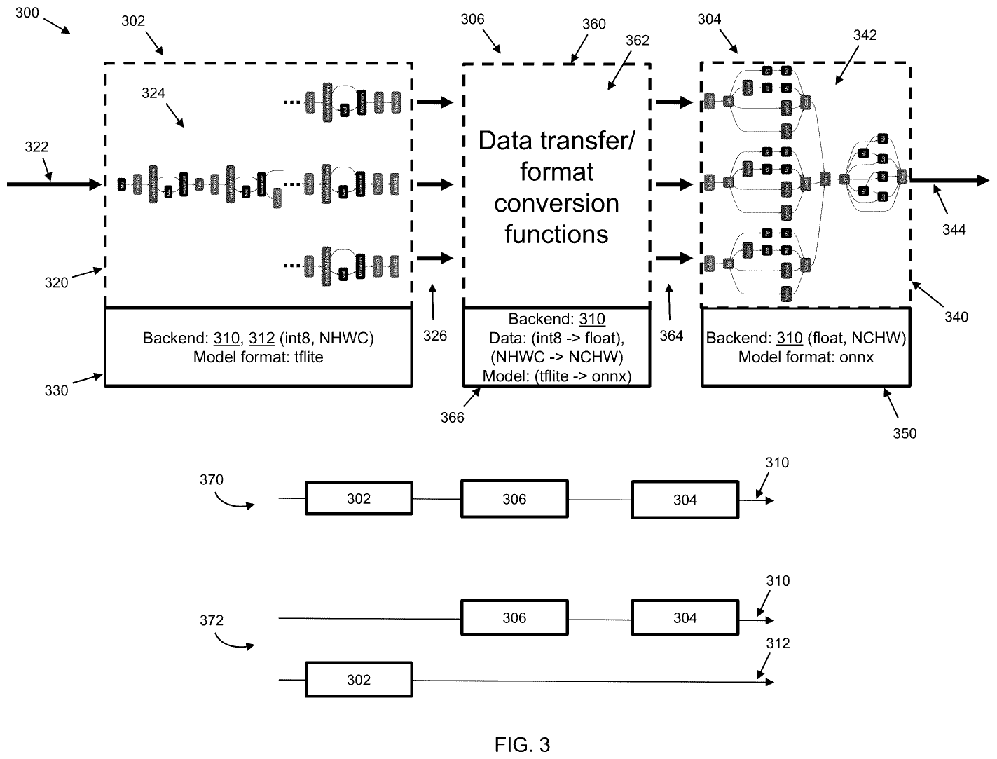

FIG. 3 illustrates another example portion of a metagraph 300 as described above, in which two sequential subgraphs 302, 304 are not directly compatible. In the example, the first subgraph 302 includes a container 320 that receives from a previous subgraph (not shown) input 322 having an 8-bit integer data type; also in the container 320, a computing body 324 is a tensor including a portion of a TFLite branching directed graph with a memory format of NHWC that executes on the input 322 to produce outputs 326 also of 8-bit integer data type. These outputs 226 cannot be used to execute the computing body 342 stored in or referenced by the container 340 of the second subgraph 304, because the second subgraph is configured to operate on inputs having floating-point data type, and the computing body 342 is a tensor including a portion of an ONNX branch-resolving directed graph with a memory format of NCHW that produces an output 344 also having a floating-point data type. The metagraph 300 enables a data conversion or a layout conversion, or both, through the inclusion of a conversion subgraph 306.

A conversion subgraph 306 may have a container 360 including data structures, executable code, or other information for receiving input having one set of characteristics and for producing and sending output having a different set of characteristics. For example, the input specified by the container 360 may be a set of fields with a first set of values corresponding to the expected characteristics of the input, and the output specified by the container 360 may be the same set of fields with a second set of values corresponding to the desired characteristics of the output. A field, in this context, may be any parameter of a data element including without limitation: data type; data size; data location; various formats of the data such as file format, memory storage format, compiler format; and the like. A field may also be a parameter of a computing body or of an AIML model or graph, such as executable format (e.g., AOT binary or container structure), model format (e.g., TFLite, ONNX), and the like. A field may also be a parameter of a hardware target on one of the available backends, such as an instruction set or architecture or a required data type.

A computing body 362 of a conversion subgraph 306 includes the executable functions that transform (i.e., perform the conversion or transfer of) the input data to produce output data 364 having the desired characteristics. In the illustrated example, the functions of the computing body 362 perform several conversions of the input data, which is the outputs 326 of the first subgraph 302: the data type is converted from 8-bit integer (int8) to floating point (float) using any suitable data type conversion function; a tensor memory reference function is used to reshape the input data from the NHWC sequence to the NCHW sequence; and, the input data including TFLite library/function calls and data structures is modified as needed so it can be read by an ONNX model. Additionally, the output data 364 may be stored in a different location in device memory than the outputs 326 of the first subgraph 302 were stored. For example, the first subgraph 302 may be executed by a DSP of the computing device, and the outputs 326 may be stored in internal memory of the DSP; the computing body 362 may include one or more functions that copy the outputs 326 to a memory space accessible by a CPU executing the second subgraph 304, or that simply store the outputs 364 of the conversion graph 306 in such CPU-accessible memory. It will be understood that the conversion subgraph 306 may instead include multiple sequential or nested subgraphs that are each dedicated to performing one specific conversion (e.g., int8 to float data type); when the metagraph 300 is built, the appropriate selection and arrangement of such dedicated conversion graphs will be included.

The subgraphs 302-306 each include corresponding meta information 330, 350, 366 that is used to create the ES profiles of the metagraph 300 and, ultimately, to schedule execution of the subgraphs 302-306. In this case, each meta information 330, 350 identifies, for each subgraph 302, 304: the compatible backend (i.e., a first backend 310, a second backend 312, or both); the data precision of the input and output; the memory format of the data used in each compute body 324, 342; and, the format of the original AIML model from which the graph portions are derived. The corresponding meta information 330, 350 indicates a mismatch of several graph parameters between the subgraphs 302, 304 match; the mismatched parameters determine which data transfer/format conversion functions are needed in the computing body 362 of the conversion graph 306. The meta information 366 of the conversion graph 306 identifies the destination backend(s) for the converted data, i.e., the compatible backend of the next subgraph in the sequence. The meta information 366 may also indicate the conversions that the conversion graph 306 performs. In the illustrated example, there are two possible ES profiles 370, 372 because the first subgraph 302 can be executed on either the first backend 310 or the second backend 312, while the second subgraph 304 must be executed on the first backend 310. The conversion graph 306 may be executed on the first backend 310 (which may include the CPU), causing the CPU to perform data layout/type conversion of stored data to the format(s) required by the DSP on the second backend 312; the CPU then stores the converted data to an external memory buffer of the DSP on the second backend 312, and the DSP may copy (or DMA transfer) the data from the external memory buffer to an internal buffer of the DSP for processing.

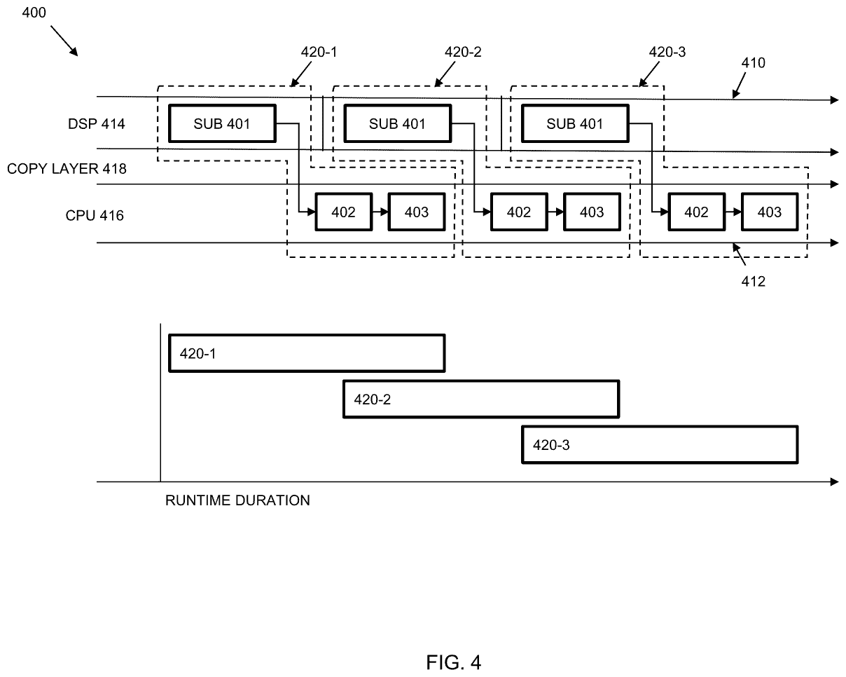

As noted above with respect to FIG. 1, execution can be scheduled so that, within a time that a first subgraph of the metagraph is assigned and allocated resources to execute on a first backend, another subgraph, sequence of subgraphs, or set of subgraphs that do not have any data dependencies on the output(s) or other data of the first subgraph execution, and that can be executed on other backends, may be scheduled to execute in parallel with the execution of the first subgraph. Referring to FIG. 4, the use of the metagraph to schedule execution of portions of the AIML model in parallel provides for implementation of an execution schedule 400 that uses frame pipelining across multiple backends 410, 412 of a computing device executing the metagraph. In the illustrated example, a first backend 410 includes one of the computing devices DSPs 414 as its primary processing unit; and, a second backend 412 includes at least one of the cores of the computing device's CPU 416. A first subgraph 401 of the metagraph may be executed on the first backend 410, and may also be configured for execution on the second backend 412; however, a second subgraph 402 and a sequential third subgraph 403 must be executed on the second backend 412, so the first subgraph 401 is assigned to the first backend 410 to enable the frame pipelining. A copy layer 418 represents the interface between the two backends 410, 412. In some embodiments of a computing device, the data processing of the DSP 414 may be performed using internal memory of the DSP 414; processed data, such as the output of the first subgraph 401, may need to be copied to another memory device that is accessible by the CPU 416, such as an external memory module of the DSP 414, so that the data can be used as input to the second subgraph 402. The copying step requires both time and hardware computing resources; both of these factors are accounted for in the execution scheduling profile that implements the execution schedule 400.

The depicted execution schedule 400 represents a pipeline formed from hardware of the multiple backends, on which execution of sequential frames 420-1,2,3 can be executed in parallel. A frame, in this context, includes a subset, such as a branch of the subgraphs 401-403 in the metagraph, which can be at least partially parallel-processed due to a break in data dependency. The first backend 410 begins execution of a first frame 420-1. Then, at a predefined point in the execution process, the intermediate results (e.g., an output of a subgraph execution) are passed through the copy layer 418 to the second backend 412 for further processing. The first backend 410 can the begin execution of the second frame 420-2, and then the third frame 420-3, and so on. The composition of a frame (i.e., the set of subgraphs 401-403 to include, and their distribution across the backends 410, 412) is selected to minimize or eliminate back-and-forth dependencies between the backends 410, 412. As depicted by example in FIG. 4, frames are processed in a pipeline when different subgraphs of a frame can be executed on different backends. Thus, the parallel processing of frames is possible as a first frame 420-1 processing is overlapped with that of a second frame 420-2; also, part of the second frame 420-2 processing is overlapped with a third frame 420-3 processing, and so on. For a given amount of frames to be processed, relative to sequential execution of the subgraphs, the total process time is reduced and the processing throughput is increased. It will be understood that frame pipelining (and associated performance gain) requires multiple backends; if the computing resources are not available across the multiple backends, sequential execution will be selected and it requires a single context.

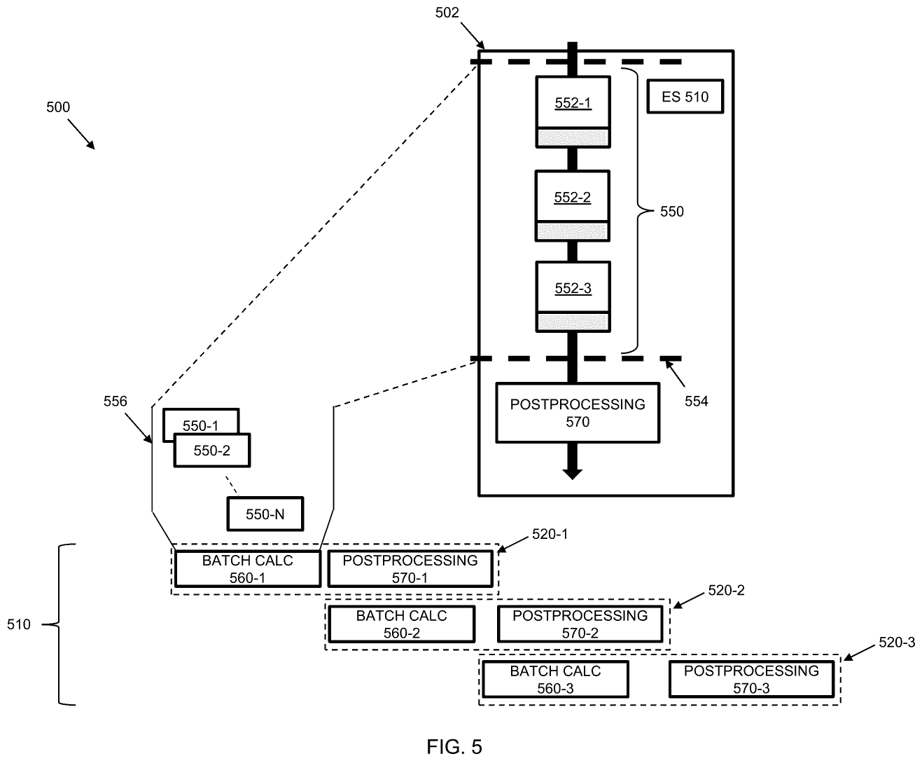

FIG. 5 illustrates an example method 500 of batch processing one or more portions of a metagraph 502, such as a branch or other subset of subgraphs 552-1,2,3 within the metagraph 502. The subset of subgraphs 552-1-3 may execute serially or in parallel up to a sync barrier 554 defined in the metagraph 502 as described above. The metagraph 502 may include information indicating that the subgraphs 552-1-3 may be executed as a frame 550, and further that the frame 550 may be allocated in an execution schedule 510 for batch processing. “Batch processing” in the present context refers to the repeated partial or complete execution of a select plurality of subgraphs, such as a frame 550, a predetermined number of times to produce an aggregate output that is then further processed. The metagraph 502 or the execution schedule 510, or both, may include a postprocessing section 570 including instructions for processing the aggregate output of a batch of processed frames 550. Thus, as illustrated, a batch 520-1,2,3 includes N instances 550-1, 2, . . . , N of a frame 550; in a first batch 520-1, each instance 550-1-N is processed in a batch calculation 560-1. All N instances 550-1-N of the frame 550 must be executed before the batch calculation 560-2 of the next batch 520-2 can begin. Once the batch calculation 560-1 is complete, the output, including the resulting data of executing N instances 550-1-N of the frame 550, is passed to postprocessing 570-1, and the next batch calculation 560-2 can begin; the output of the second batch calculation 560-2 is passed to postprocessing 570-2, and the batch calculation 560-3 of the next batch 520-3 can begin, passing to postprocessing 570-3, and so on.

Using implementations of the present metagraph 502, the AIML model may be partitioned so that instances 550-1-N of the frame 550 are deployed and executed across multiple backends in a frame pipeline 556 as described above. In some embodiments, the batch calculations 560-1 can be performed on a first backend that has fast execution, such as a DSP, and the postprocessing 570-1 can be performed on a different backend including a CPU that has suitable memory capacity. The output of each instance 550-1-N of a frame 550 can be passed to the CPU as soon as it is produced, freeing memory in the DSP to process the next instance 550-1-N; once all instances 550-1-N in a batch 520-1 have been executed, the CPU may perform the postprocessing 570-1 on the aggregate results, while the DSP moves to the next batch 520-2 of frames. Thus, the metagraph 502 defines a multi-level representation of the AIML model: a first level includes the graph-partitioned subgraphs 552-1-3 that contain portions of the AIML model executable, along with hardware- and software-aware meta information; a second level includes the frame(s) 550, each including a subset of the subgraphs 552-1-3 along with execution orders that enable parallel execution of the subgraphs 552-1-3 so that instances 550-1-N of the frame(s) 550 can be executed in a frame pipeline 556; and, a third level of the metagraph 502 includes the batch 520-1 including a plurality of instances 550-1-N of the frame(s) 550 to be executed in a batch calculation 560-1 that is synchronized according to the sync barrier 554, and then the output of the batch calculation 560-1 of the instances 550-1-N will be aggregated and processed in a batch postprocessing operation 570-1. Additionally, multiple batches 520-1-3 can be executed in parallel; for example, while the aggregated output of a first batch calculation 560-1 is undergoing postprocessing 570-2, the next batch calculation 560-2 can be started.

Batch processing as described herein can be used to optimize AIML computation. Batch inferencing, also known as offline inferencing, performs predictions on a batch of input data, which is good for large datasets without the requirement of real time response. Also, certain AIML models, such as faster region-based convolutional neural network (R-CNN) based object detection model, have first stage processing results from a batch of detected object candidates which are then fed into second stage processing to determine final object locations and classification results. These types of AIML algorithms essentially create intermediate results whose further processing benefit from batch inference. Also, stateful long short-term memory (LSTM) processing is typically used together with batch calculation, as one input calculation in the batch needs the previous LSTM state. This disclosure supports a multilevel parallel processing pipeline, in which the frame pipeline represents first-level processing and the batch processing pipeline represents second-level processing.

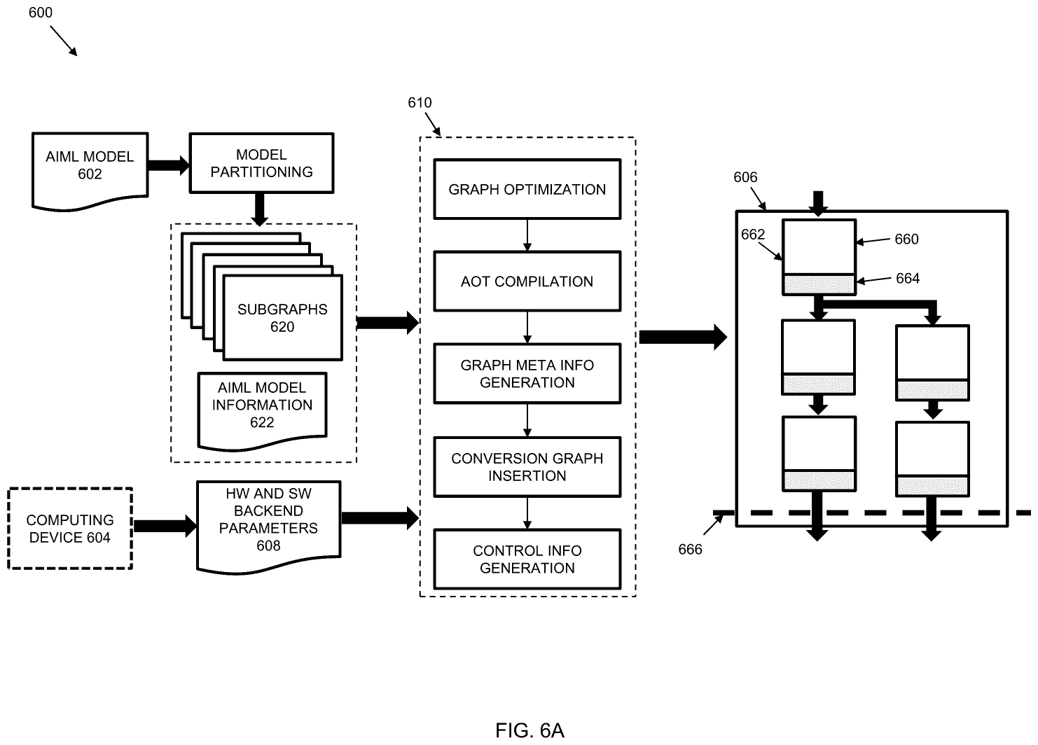

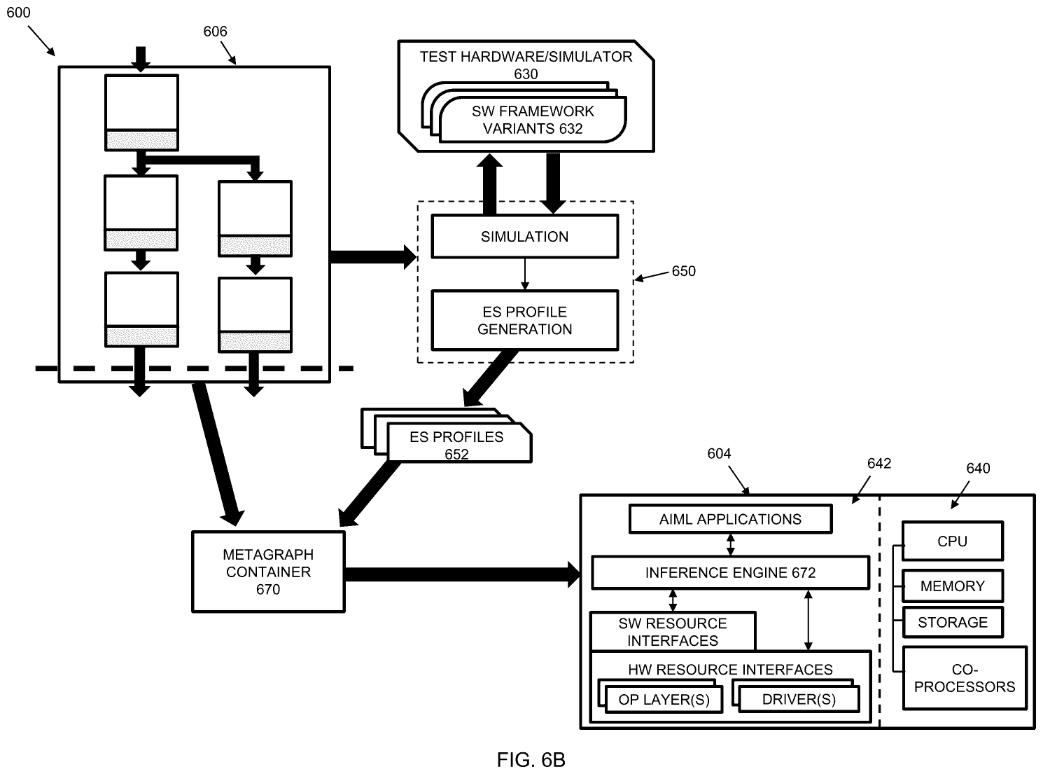

It will be understood that the present systems and methods can be implemented for existing and subsequently developed AIML models according to their contents and formats, which are much larger and more complicated than the simplified representations illustrated in the Figures and described above. Additionally, the present systems and methods can be implemented for, and between, the processing and storage backends of any existing and subsequently developed computing device, accounting for both the hardware and the software deployed on the computing device. Thus, referring to FIGS. 6A and 6B, the present hardware- and software-aware metagraph-based AIML model deployment system 600 for optimized execution of an AIML model 602 in heterogenous computing environments includes a deployable metagraph container 670 that is executable on the target hardware of a heterogenous computing device 604. The metagraph container 670 may include a metagraph 606 such as a directed graph of meta-annotated subgraphs 660 that represent the AIML model 602, and additional information enabling optimized execution scheduling of the metagraph 606 at runtime on the computing device 604.

The present system 600 includes an offline toolset that may be made available to a user of the system 600 via a user interface that enables the user to provide to the system 600 the AIML model 602, information describing the hardware and software constraints of the computing device 604 (referred to herein as hardware and software backend parameters 608), and other inputs to the metagraph 606 building processes. The system 600 may be configured to partition the AIML model 602 into a set of subgraphs 620 each containing or representing a portion of the AIML model 602. The model partitioning may further produce a file, data structure, or other data set of AIML model information 622, which may include information about the AIML model 602 or about the subgraphs 620, or both, such as input/output details, edge data, weights, data precision and format, container format, and the like. In some embodiments, the AIML model 602 may include portions that have different characteristics, such as container format, compiler type, hardware-specific or customized operations, and the like, and partitioning the AIML model 602 may generate sets of interrelated subgraphs that are optimized for execution on different hardware components. For example, the AIML model 602 may be a neural network model with a first portion that includes a set of user-created operations encoded in TFLite containers, which when executed produce output that is fed as input into a second portion of the AIML model 602 including open-source containers (e.g., in ONNX format) compiled using the Glow compiler; partitioning this AIML model 602 may create a first set of subgraphs 620 representing the first portion, a second set of subgraphs 620 representing the second portion, and AIML model information 622 describing the edges between the first and second sets of subgraphs 620.

The system 600 further includes a metagraph building module, or metagraph builder 610, that receives as input the plurality of subgraphs 620, the AIML model information 622, and the set of device parameters 608 describing the computing resources (i.e., the hardware arrangement and software execution environment) that define the backend(s) of the target computing device 604; the metagraph builder 610 produces the metagraph 606 as output. The metagraph builder 610 may be configured to perform a set of data transformations and data generation steps to transform the subgraphs 620 into the metagraph 606, including those illustrated by example. In some embodiments, the metagraph builder 610 may, based on some embodiments on the AIML model information 622, perform graph analysis and optimization of the subgraphs 620 to produce the subgraphs 660 and corresponding edge information in the metagraph 606. Graph optimization may include processing that is hardware-agnostic or that is hardware-specific. Non-limiting example hardware-agnostic optimizations include structure simplification and constant folding; non-limiting examples of hardware-specific optimizations include data layout changes and fusion of known operations and instruction sets with additional operations that are supported by a given hardware target or are provided by a user.

The metagraph builder 610 may perform AOT compilation of AIML model computing bodies in the graph entity 662 of various subgraphs 660. As described above with respect to FIG. 1, a corresponding subgraph 660 thus may store multiple versions of the computing body in different formats, so that the optimal version of the computing body can be selected at runtime. Thus, the metagraph builder 610 can store, for example, both a model container format of the computing body of the subgraph 660, and a pre-compiled binary executable of the same computing body, in the corresponding graph entity 662. Additionally or alternatively, the metagraph builder 610 may generate other types of multi-format computing bodies, such as to accommodate different software frameworks for a given hardware component as described above; the metagraph builder 610 may store these in the graph entity 662 of the corresponding subgraph(s) 660.

The metagraph builder 610 may use any of the input, and any data generated by the metagraph builder 610 during performance of other steps, to determine the parameters and constraints of each subgraph 660 and generate the meta information 664 therefor. The meta information 664, as described above, includes parameters that describe the subgraph 660 for purposes of determining the ways the subgraph 660 can be executed on the target device's hardware. For example, in some embodiments the inputs to the metagraph builder 610 may include information identifying which backends a given subgraph can execute on In some embodiments, this “backend compatibility” information can be provided by the user (e.g., via the user interface) as an input to the graph building process.

The metagraph builder 610 may further optimize the execution of the metagraph 606 on the computing device 604 by inserting one or more conversion subgraphs at appropriate points between subgraphs 660 that require data conversions or transfers between them, as described above with respect to FIG. 3. In some embodiments, conversion graphs may be inserted during offline graph analysis, by inspecting the corresponding data format/layout of consecutive subgraphs to identify differences; if the formats/layouts are compatible, no conversion graph is inserted, otherwise a suitable conversion graph, based on the identified differences, is selected and inserted between the subgraphs. Conversion graphs may be provided through a graphs library accessible by the builder, or in connection with specific hardware, depending on the platforms. In some embodiments, some or all of the conversion graphs may be generic and allocatable on different accelerators.

The metagraph builder 610 may also generate various control information including limitations on the execution of various subgraphs 660, and may store the control information in the metagraph 606. For example, the metagraph builder 610 may identify one or more data dependencies or data synchronization requirements that indicate a sync barrier 666 should be inserted between certain subgraphs, which will cause the runtime execution environment to wait for all subgraphs 660 up-graph of the sync barrier 666 to finish executing. Such control information can be implicit, derived from subgraph inputs and outputs connection, or inserted explicitly through sync barrier syntax. In another example, a data dependency may prevent a given subgraph 660 from being executed in parallel; the metagraph builder 610 may identify this dependency and store in the meta information 664 for the corresponding subgraph 660 an indicator that will be read by the execution scheduler to prevent parallel execution.

In this manner, the metagraph builder 610 effectively maps the AIML model 602 to the given hardware arrangement and supporting software framework of the computing device 602. Data of the metagraph 606 is formatted as described above and stored; in various embodiments, the metagraph 606 includes executable code (e.g. binaries) stored as compute bodies in the respective subgraphs. Additionally, the metagraph 606 may include object, header, and other library files that define elements of the AIML model 602 such as containers, objects, weights, edges, and sync and other control information. Various data, or all data, of the metagraph 606 may be serialized into one or more data blocks or binary objects or a combination thereof; in some embodiments, various serialized data may be in human-readable or high-level programming languages such as flatbuffer and JSON. The metagraph builder 610 may output the completed metagraph 606 for generation of execution scheduling profiles that can be used to adapt execution scheduling of the subgraphs based on hardware and software computing resource availability. As shown in FIG. 6B, the metagraph 606 may be passed to a metagraph execution scheduling profiling module, or “metagraph profiler” 650. The metagraph profiler 650 may be in communication with a test setup 630 including sample hardware representing the computing device 604, simulation software, or both. The test setup 630 may be configured with the same hardware computing resources that will be available on the computing device 604 deployed in the field; or, variants of the hardware arrangement 640 may be provided. Additionally, the test setup 630 may be equipped with the same software that will be deployed on the computing device 604, or with as many elements of the software framework as is known at the time of generating the metagraph 606 or the metagraph container 670. In some embodiments, the test setup 630 may include a plurality of software variants 632 each representing a different software framework that, based on the hardware arrangement 640, the metagraph 606 might be executed upon in the field. In this manner, the test setup 630 provides a suitable representation of the different backends of the computing device 604 upon which the metagraph 606 may be deployed.

The metagraph profiler 650 executes the metagraph 606 on the test setup 630 a plurality of times to obtain and benchmark execution results for the different iterations of the test setup 630. Simulating the metagraph 606 may include scheduling execution of the subgraphs across the backends according to various “schedules,” i.e., sets of scheduling orders arranged to cause the directed graph of subgraphs in the metagraph 606 to be deployed across the available backends in different ways and executed as described above. During and after the simulated execution(s) of the metagraph 606 according to each schedule, the metagraph profiler 650 evaluates impacts on performance, such as execution time, memory usage, hardware computing resource consumption, device interrupts and conflicts with software in the software execution environment 642, and the like. Over a suitable number of simulations, the metagraph profiler 650 may generate one or more execution scheduling profiles 652 each having a different schedule. In some embodiments, each of the schedules associated with one of the execution scheduling profiles 652 may be composed of scheduling orders designed to achieve certain execution goals (e.g., fastest execution, least memory usage, etc.) or to accommodate real-time resource availability given the constraints on both hardware and software.

The metagraph 606 and execution scheduling profiles 652 are stored in the metagraph container 670, which is deployed to the computing device 604 having a hardware arrangement 640 and a software execution environment 642 as described above with respect to FIG. 1. The present system further includes a runtime inference engine 672 executing in the software execution environment 642 of the computing device 604. The runtime inference engine 672 is capable of consuming the metagraph 606, dynamically selecting an optimal execution scheduling profile 652 based on real-time operating conditions and executing the AIML model accordingly with minimal runtime overhead.

The present disclosure describes various implementations of a metagraph implementation for AIML models, that enables execution of the AIML model based on the hardware and software constraints of a computing device. In some aspects, the disclosure provides a computing device including multiple cores, one or more hardware accelerators, one or more memories, and an interconnection framework that couples the cores, the one or more accelerators and the one or more memories to permit programs to be executed by the computing device on a plurality of backends of the computing device. The computing device further includes a metagraph container stored in one or more of the memories, the metagraph container including: a metagraph including a plurality of subgraphs representing an artificial intelligence/machine learning (AIML) model and organized into a directed graph, each of the subgraphs including meta information describing execution parameters of the corresponding subgraph; and, one or more execution scheduling profiles each describing a corresponding schedule of a plurality of schedules for assigning execution of the plurality of subgraphs across the plurality of backends. The computing device further includes a runtime inference engine executing in a software execution environment of the computing device and in communication with the multiple cores, the multiple hardware accelerators, the interconnection framework, and the multiple memories, the runtime inference engine configured to execute the AIML model according to the metagraph and the one or more execution scheduling profiles.

The meta information may be derived from a hardware arrangement associated with the plurality of backends. The meta information may further be derived from a software framework associated with one or more of the programs to be executed by the computing device. The execution parameters of each corresponding subgraph of the plurality of subgraphs may include backend compatibility information identifying which of the plurality of backends is configured to execute the corresponding subgraph, and the corresponding schedule of each of the one or more execution scheduling profiles may assign execution of the plurality of subgraphs according to the backend compatibility information. The metagraph may further include a frame including a subset of the plurality of subgraphs that, according to the backend compatibility information corresponding to each of the subgraphs in the subset, are executable in parallel across a first backend and a second backend of the plurality of backends.

The metagraph may further include: a sync barrier positioned in the directed graph and indicating that execution of the plurality of subgraphs must be paused until each of the plurality of subgraphs that is upgraph of the sync barrier has completed executing; a frame including a subset of the plurality of subgraphs that are upgraph of the sync barrier; and, a batch identifying a number of instances of the frame that must be executed to pass the sync barrier, the computing device aggregating a plurality of outputs each associated with execution of a corresponding one of the instances to produce an aggregate output. The computing device may be configured to execute a plurality of instances of the batch in parallel.

The plurality of subgraphs may include a conversion subgraph configured to convert an output of a first of the plurality of subgraphs from a first format to a second format readable by a second of the plurality of subgraphs. Each of the plurality of subgraphs may further include a graph entity storing one or more computing bodies created from the AIML model. The corresponding graph entity of a first of the plurality of subgraphs may include a first computing body in a first format and a second computing body in a second format; and, the one or more execution scheduling profiles may include a determination of whether to execute the first computing body or the second computing body based on available hardware computing resources of the plurality of backends.

In another aspect, the present disclosure provides a system for configuring an artificial intelligence/machine learning (AIML) model to execute on a computing device having a hardware arrangement that includes a CPU having one or more cores, one or more hardware accelerators, multiple memories, and an interconnection framework that couples the one or more cores, the hardware accelerators, and the memories to permit programs to be executed by the computing device. The system includes a metagraph builder composed of computer program instructions that, when executed by one or more of a plurality of processors, cause the one or more processors to: determine, based on the hardware arrangement and one or more of the programs, a plurality of backends of the computing device; determine a partitioning of the AIML model into a directed graph including an arrangement of subgraphs; transform the arrangement of subgraphs into a metagraph executable by the computing device, the metagraph including a plurality of meta-enabled subgraphs each including meta information describing execution parameters of the corresponding meta-enabled subgraph, the execution parameters associated with the plurality of backends; and, output the metagraph for execution on the computing device.

Each of the subgraphs in the directed graph may include a computation body implementing a portion of the AIML model, the computation body including program code. To transform the arrangement of subgraphs, executing the computer program instructions of the metagraph builder causes the one or more processors to: generate a first copy of the computation body associated with a first subgraph of the subgraphs in the directed graph, the first copy including the program code in a first format executable on a first backend of the plurality of backends of the computing device; generate a second copy of the computation body associated with the first subgraph, the second copy including the program code in a second format executable on a second backend of the plurality of backends of the computing device; associate, in the metagraph, the first and second copies with a first meta-enabled subgraph of the plurality of meta-enabled subgraphs; and, create in the execution parameters of the first meta-enabled subgraph information for selecting the first copy for execution when the first meta-enabled subgraph is executed on the first backend and selecting the second copy for execution when the first meta-enabled subgraph is executed on the second backend.

To transform the arrangement of subgraphs, executing the computer program instructions of the metagraph builder may cause the one or more processors to determine, based on the meta information corresponding to a first and a second meta-enabled subgraph of the plurality of meta-enabled subgraphs, that: execution of the first meta-enabled subgraph produces an output that is provided as an input for execution of the second meta-enabled subgraph; and, the output is formatted according to a first format and the second meta-enabled subgraph requires the input to be formatted according to a second format at least partially incompatible with the first format. The metagraph builder may then obtain a conversion subgraph configured to convert data in the first format to the second format, and insert the conversion subgraph into the metagraph between the first meta-enabled subgraph and the second meta-enabled subgraph.

The system may further include a metagraph profiler including computer program instructions that, when executed by one or more of the plurality of processors, cause the one or more processors to: obtain the metagraph; based on corresponding meta information of each of the plurality of meta-enabled subgraphs, generate a plurality of schedules of assigning execution of the plurality of meta-enabled subgraphs across the plurality of backends; cause a plurality of simulations on test hardware representing the computing device, each of the plurality of simulations executing the AIML model according to the metagraph and a corresponding schedule of the plurality of schedules, the plurality of simulations producing simulation results; based on the simulation results and one or more performance metrics, generate a plurality of execution schedule profiles each comprising a corresponding schedule, of the plurality of schedules, associated with the simulation results that satisfy the one or more performance metrics; generate a metagraph container including the metagraph, the plurality of execution schedule profiles, and program code executable by the computing device to select one of the plurality of execution schedule profiles based on real-time availability of computing resources of the hardware arrangement; and, store the metagraph container in one or more of the memories of the computing device. The one or more performance metrics may include execution speed, and a first of the plurality of execution scheduling profiles may include a first schedule of the plurality of schedules, the simulation results indicating that the test hardware executed the AIML model in the shortest time when the plurality of meta-enabled subgraphs were executed according to the first schedule.

In yet another aspect, the present disclosure provides a method of configuring a computing device to execute an artificial intelligence/machine learning (AIML) model, the computing device having a hardware arrangement including a CPU, one or more hardware accelerators, one or more memories, and an interconnection framework that couples the CPU, the one or more hardware accelerators, and the one or more memories to permit programs to be executed by the computing device. The method includes the steps of: determining, based on the hardware arrangement and one or more of the programs, a plurality of backends of the computing device, each of the plurality of backends defining a different combination of computing resources allocated from the hardware arrangement for executing the AIML model; obtaining one or more object files including program code representing the AIML model as a directed graph; transforming the one or more object files to produce a metagraph executable by the computing device, the metagraph including a plurality of subgraphs each comprising meta information describing execution parameters of the corresponding subgraph, the execution parameters associated with the plurality of backends; based on corresponding meta information of each of the plurality of subgraphs, generating a plurality of execution scheduling profiles including program code readable by the computing device to control assignment of the plurality of subgraphs for execution across the plurality of backends; generating a metagraph container including program code readable by the computing device to select an execution schedule profile and cause the metagraph to be executed on the computing device; and, outputting the metagraph container to the computing device.

Transforming the one or more object files may include the steps of: associating each of the plurality of subgraphs with a computation body implementing a portion of the AIML model, the computation body including program code; generating a first copy of the computation body associated with a first of the plurality of subgraphs, the first copy including the program code in a first format executable on a first backend of the plurality of backends of the computing device; generating a second copy of the computation body associated with the first subgraph, the second copy including the program code in a second format executable on a second backend of the plurality of backends of the computing device; storing the first and second copies in the metagraph in association with the first subgraph; and, creating in the execution parameters of the first subgraph information for selecting the first copy for execution when the first subgraph is executed on the first backend and selecting the second copy for execution when the first subgraph is executed on the second backend. Generating the first copy may include compiling the program code of the computation body corresponding to the first subgraph to produce the first copy in binary executable format; generating the second copy may include formatting the program code of the computation body corresponding to the first subgraph to produce the second copy in an object file format that is interpreted by the computing device at runtime execution of the metagraph.

The method may further include the steps of: determining, based on the meta information corresponding to a first and a second subgraph of the plurality of subgraphs, that execution of the first subgraph produces an output that is provided as an input for execution of the second subgraph, and that the output is formatted according to a first format and the second subgraph requires the input to be formatted according to a second format that is at least partially incompatible with the first format; obtaining a conversion subgraph configured to convert data in the first format to the second format; and, inserting the conversion subgraph into the metagraph between the first subgraph and the second subgraph.

Generating the plurality of execution scheduling profiles may include the steps of: based on corresponding meta information of each of the plurality of subgraphs, generating a plurality of schedules of assigning execution of the plurality of subgraphs across the plurality of backends; causing test hardware representing the computing device to perform a plurality of simulations, each of the plurality of simulations executing the AIML model according to the metagraph and a corresponding schedule of the plurality of schedules, the plurality of simulations producing simulation results; and, based on the simulation results and one or more performance metrics, selecting for each of the plurality of execution scheduling profiles a corresponding schedule, of the plurality of schedules, associated with the simulation results that satisfy the one or more performance metrics.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. It should be understood that such terms are utilized to provide a clear description of an implementation of the invention and that the various bit sequencing may be implemented in any order in memory and, in fact, the multiple bits making up a given source code, instruction, or other word could be implemented in different regions of a memory or across multiple different memory devices. Similarly, the present description may describe a stored indicator being set when having a signal value greater than a threshold and cleared when the cell's signal value is less than that threshold. It will be apparent to the person of ordinary skill in the art that such definitions may be reversed so that a particular cell may be set when its signal value falls below a threshold and the cell is cleared when its value falls above the same or a different threshold.

The term “coupled” is defined as connected, although not necessarily directly, and not necessarily mechanically. The terms “a” and “an” are defined as one or more unless stated otherwise. The terms “comprise” and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A computing device comprising:
multiple cores, one or more hardware accelerators, one or more memories, and an interconnection framework that couples the cores, the one or more accelerators and the one or more memories to permit programs to be executed by the computing device on a plurality of backends of the computing device;
a metagraph container stored in one or more of the one or more memories, the metagraph container comprising:
a metagraph comprising a plurality of subgraphs representing an artificial intelligence/machine learning (AIML) model and organized into a directed graph, each of the subgraphs comprising meta information describing execution parameters of the corresponding subgraph; and
one or more execution scheduling profiles each describing a corresponding schedule of a plurality of schedules for assigning execution of the plurality of subgraphs across the plurality of backends; and
a runtime inference engine executing in a software execution environment of the computing device and in communication with the multiple cores, the one or more hardware accelerators, the interconnection framework, and the one or more memories, the runtime inference engine configured to execute the AIML model according to the metagraph and the one or more execution scheduling profiles.

2. The computing device of claim 1, wherein the meta information is derived from a hardware arrangement comprising the plurality of backends.

3. The computing device of claim 2, wherein the meta information is further derived from a software framework comprising one or more of the programs to be executed by the computing device.

4. The computing device of claim 1, wherein the execution parameters of each corresponding subgraph of the plurality of subgraphs include backend compatibility information identifying which of the plurality of backends is configured to execute the corresponding subgraph, and wherein the corresponding schedule of each of the one or more execution scheduling profiles assigns execution of the plurality of subgraphs according to the backend compatibility information.

5. The computing device of claim 4, wherein the metagraph further comprises a frame comprising a subset of the plurality of subgraphs that, according to the backend compatibility information corresponding to each of the subgraphs in the subset, are executable in parallel across a first backend and a second backend of the plurality of backends.

6. The computing device of claim 1, wherein the metagraph further comprises:
a sync barrier positioned in the directed graph and indicating that execution of the plurality of subgraphs must be paused until each of the plurality of subgraphs that is upgraph of the sync barrier has completed executing;
a frame comprising a subset of the plurality of subgraphs that are upgraph of the sync barrier; and
a batch identifying a number of instances of the frame that must be executed to pass the sync barrier, the computing device aggregating a plurality of outputs each associated with execution of a corresponding one of the instances to produce an aggregate output.

7. The computing device of claim 6, wherein the computing device is configured to execute a plurality of instances of the batch in parallel.

8. The computing device of claim 1, wherein the plurality of subgraphs includes a conversion subgraph configured to convert an output of a first of the plurality of subgraphs from a first format to a second format readable by a second of the plurality of subgraphs.

9. The computing device of claim 1, wherein each of the plurality of subgraphs further comprises a graph entity storing one or more computing bodies created from the AIML model.

10. The computing device of claim 9, wherein the corresponding graph entity of a first of the plurality of subgraphs comprises a first computing body in a first format and a second computing body in a second format, and wherein the one or more execution scheduling profiles include a determination of whether to execute the first computing body or the second computing body based on available hardware computing resources of the plurality of backends.

11. A system for configuring an artificial intelligence/machine learning (AIML) model to execute on a computing device having a hardware arrangement comprising a CPU having one or more cores, one or more hardware accelerators, multiple memories, and an interconnection framework that couples the one or more cores, the hardware accelerators, and the memories to permit programs to be executed by the computing device, the system comprising:
a metagraph builder comprising computer program instructions that, when executed by one or more of a plurality of processors, cause the one or more processors to:
determine, based on the hardware arrangement and one or more of the programs, a plurality of backends of the computing device;
determine a partitioning of the AIML model into a directed graph comprising an arrangement of subgraphs;
transform the arrangement of subgraphs into a metagraph executable by the computing device, the metagraph comprising a plurality of meta-enabled subgraphs each comprising meta information describing execution parameters of the corresponding meta-enabled subgraph, the execution parameters associated with the plurality of backends; and
output the metagraph for execution on the computing device.

12. The system of claim 11, wherein each of the subgraphs in the directed graph comprises a computation body implementing a portion of the AIML model, the computation body comprising program code, and wherein to transform the arrangement of subgraphs, executing the computer program instructions of the metagraph builder causes the one or more processors to:
generate a first copy of the computation body associated with a first subgraph of the subgraphs in the directed graph, the first copy comprising the program code in a first format executable on a first backend of the plurality of backends of the computing device;
generate a second copy of the computation body associated with the first subgraph, the second copy comprising the program code in a second format executable on a second backend of the plurality of backends of the computing device;
associate, in the metagraph, the first and second copies with a first meta-enabled subgraph of the plurality of meta-enabled subgraphs; and
create in the execution parameters of the first meta-enabled subgraph information for selecting the first copy for execution when the first meta-enabled subgraph is executed on the first backend and selecting the second copy for execution when the first meta-enabled subgraph is executed on the second backend.

13. The system of claim 11, wherein to transform the arrangement of subgraphs, executing the computer program instructions of the metagraph builder causes the one or more processors to:
determine, based on the meta information corresponding to a first and a second meta-enabled subgraph of the plurality of meta-enabled subgraphs, that:
execution of the first meta-enabled subgraph produces an output that is provided as an input for execution of the second meta-enabled subgraph; and
the output is formatted according to a first format and the second meta-enabled subgraph requires the input to be formatted according to a second format at least partially incompatible with the first format;
obtain a conversion subgraph configured to convert data in the first format to the second format; and
insert the conversion subgraph into the metagraph between the first meta-enabled subgraph and the second meta-enabled subgraph.

14. The system of claim 11, further comprising a metagraph profiler comprising computer program instructions that, when executed by one or more of the plurality of processors, cause the one or more processors to:
obtain the metagraph;
based on corresponding meta information of each of the plurality of meta-enabled subgraphs, generate a plurality of schedules of assigning execution of the plurality of meta-enabled subgraphs across the plurality of backends;
cause a plurality of simulations on test hardware representing the computing device, each of the plurality of simulations executing the AIML model according to the metagraph and a corresponding schedule of the plurality of schedules, the plurality of simulations producing simulation results;
based on the simulation results and one or more performance metrics, generate a plurality of execution schedule profiles each comprising a corresponding schedule, of the plurality of schedules, associated with the simulation results that satisfy the one or more performance metrics;
generate a metagraph container comprising:
the metagraph;
the plurality of execution schedule profiles; and
program code executable by the computing device to select one of the plurality of execution schedule profiles based on real-time availability of computing resources of the hardware arrangement; and
store the metagraph container in one or more of the memories of the computing device.

15. The system of claim 14, wherein the one or more performance metrics includes execution speed and a first of the plurality of execution scheduling profiles comprises a first schedule of the plurality of schedules, the simulation results indicating that the test hardware executed the AIML model in the shortest time when the plurality of meta-enabled subgraphs were executed according to the first schedule.

16. A method of configuring a computing device to execute an artificial intelligence/machine learning (AIML) model, the computing device having a hardware arrangement comprising a CPU, one or more hardware accelerators, one or more memories, and an interconnection framework that couples the CPU, the one or more hardware accelerators, and the one or more memories to permit programs to be executed by the computing device, the method comprising:
determining, based on the hardware arrangement and one or more of the programs, a plurality of backends of the computing device, each of the plurality of backends defining a different combination of computing resources allocated from the hardware arrangement for executing the AIML model;
obtaining one or more object files comprising program code representing the AIML model as a directed graph;
transforming the one or more object files to produce a metagraph executable by the computing device, the metagraph comprising a plurality of subgraphs each comprising meta information describing execution parameters of the corresponding subgraph, the execution parameters associated with the plurality of backends; and
based on corresponding meta information of each of the plurality of subgraphs, generating a plurality of execution scheduling profiles comprising program code readable by the computing device to control assignment of the plurality of subgraphs for execution across the plurality of backends;
generating a metagraph container comprising program code readable by the computing device to select an execution schedule profile and cause the metagraph to be executed on the computing device; and
outputting the metagraph container to the computing device.

17. The method of claim 16, wherein transforming the one or more object files comprises:
associating each of the plurality of subgraphs with a computation body implementing a portion of the AIML model, the computation body comprising program code;
generating a first copy of the computation body associated with a first of the plurality of subgraphs, the first copy comprising the program code in a first format executable on a first backend of the plurality of backends of the computing device;
generating a second copy of the computation body associated with the first subgraph, the second copy comprising the program code in a second format executable on a second backend of the plurality of backends of the computing device;
storing the first and second copies in the metagraph in association with the first subgraph; and
creating in the execution parameters of the first subgraph information for selecting the first copy for execution when the first subgraph is executed on the first backend and selecting the second copy for execution when the first subgraph is executed on the second backend.

18. The method of claim 17, wherein:
generating the first copy comprises compiling the program code of the computation body corresponding to the first subgraph to produce the first copy in binary executable format; and
generating the second copy comprises formatting the program code of the computation body corresponding to the first subgraph to produce the second copy in an object file format that is interpreted by the computing device at runtime execution of the metagraph.

19. The method of claim 16, further comprising:
determining, based on the meta information corresponding to a first and a second subgraph of the plurality of subgraphs, that:
execution of the first subgraph produces an output that is provided as an input for execution of the second subgraph; and
the output is formatted according to a first format and the second subgraph requires the input to be formatted according to a second format that is at least partially incompatible with the first format;
obtaining a conversion subgraph configured to convert data in the first format to the second format; and
inserting the conversion subgraph into the metagraph between the first subgraph and the second subgraph.

20. The method of claim 16, wherein generating the plurality of execution scheduling profiles comprises:
based on corresponding meta information of each of the plurality of subgraphs, generating a plurality of schedules of assigning execution of the plurality of subgraphs across the plurality of backends;
causing test hardware representing the computing device to perform a plurality of simulations, each of the plurality of simulations executing the AIML model according to the metagraph and a corresponding schedule of the plurality of schedules, the plurality of simulations producing simulation results; and
based on the simulation results and one or more performance metrics, selecting for each of the plurality of execution scheduling profiles a corresponding schedule, of the plurality of schedules, associated with the simulation results that satisfy the one or more performance metrics.
